(19) United States
(12) Patent Application Publication
(10) Pub. No.: US 2022/0200182 A1
(43) Pub. Date: Jun. 23, 2022

(54) METAL MATERIAL AND CONNECTION TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Mitsuhiro KUMONDAI, Mie (JP); Yoshifumi SAKA, Mie (JP); Ryota MIZUTANI, Mie (JP)

(21) Appl. No.: 17/442,896

(22) PCT Filed: Jan. 22, 2020
(86) PCT No.: PCT/JP2020/002018

§ 371 Date: Sep. 24, 2021

(30) Foreign Application Priority Data
Mar. 26, 2019 (JP) 2019-058128

(51) Int. Cl. H01R 13/03; C25D 3/30; C25D 7/00; C25D 5/50

(52) U.S. Cl. CPC H01R 13/03; C25D 5/50; C25D 7/00; C25D 3/30

(57) ABSTRACT

Provided are a metal material and a connection terminal, the metal material being capable of suppressing an increase in the friction coefficient on the surface of a Sn-containing metal layer even without using Ag. This metal material 1 has a base material 15 and a surface layer 10 with which the surface of base material 15 is covered, wherein the surface layer 10 contains Sn and In, and at least In is present on the outermost surface thereof. In addition, this connection terminal is composed of said metal material 1, and the surface layer 10 is formed on the surface of the base material 15, in at least a contact section making electrical contact with the counterpart conductive member.

### TECHNICAL FIELD

The present disclosure relates to a metal material and a connection terminal.

### BACKGROUND

As a component of an electrical connection member such as connection terminal, a metal material has been widely used which includes a substrate having a surface on which a surface layer is formed using Sn or an Sn alloy by plating or other methods. The surface layer including Sn or an Sn alloy functions to intensify the characteristics of an electric connection member, such as electric conductivity, corrosion resistance, and solder wettability on the surface of the member.

However, for cases of using Sn or most Sn alloys, adhesion and/or digging-up may easily occur if friction force is applied on the surface. Such phenomena may cause the friction coefficient for the surface to increase. If the friction coefficient is increased, the force required for insertion and removal of a connection terminal, for example, may increase.

To decrease the friction coefficient on a surface including Sn or an Sn alloy, a method has been used in which a metal layer including Sn is provided with another metal layer on its surface. For example, Patent Document 1 discloses a tinned copper alloy terminal material, in which an Sn-base surface layer is formed on a surface of a substrate including Cu or a Cu alloy; a Cu—Sn alloy layer, an Ni—Sn alloy layer, and an Ni layer or an Ni alloy layer are formed between Sn-based surface layer and the substrate in this order from Sn-base surface layer; an Ag cover layer is formed on the uppermost surface of Sn-based surface layer; and the coefficient of kinetic friction of the surface is 0.3 or less. In the terminal material disclosed in Patent Document 1, the composition is specified for the Cu—Sn alloy layer and the Ni—Sn alloy layer; and the mean spacing for the local tops of the Cu—Sn alloy layer and the thickness of Sn-base surface layer and Ag cover layer are limited to the specific range. Patent Document 1 describes that in the material, a special shape formed in the boundary between Sn-based surface layer and the Cu—Sn alloy layer, which exerts an effect of decreasing the friction coefficient; and that the material includes an Ag cover layer with a specific thickness that exerts an effect of suppressing adhesion of Sn.

### PRIOR ART DOCUMENT

### Patent Document

Patent Document 1: JP 2015-124433 A

Patent Document 2: JP 2004-179055 A

Patent Document 3: JP 2001-155955 A

Patent Document 4: JP H04-340756 A

### SUMMARY OF THE INVENTION

### Problems to be Solved

As described in Patent Document 1, increase of the friction coefficient that may occur due to adhesion of Sn can be suppressed by covering the surface of a metal layer including Sn with Ag. However, Ag in itself has a high adhesion characteristic, and if friction force is repeatedly applied to the surface of a metal layer including Sn and covered with Ag, the friction coefficient for Sn may not be effectively decreased. In addition, Ag is easily sulfurized with sulfur-containing molecules present in the air and easily gets discolored to yellow. Further, Ag is a noble metal and is a costly element; if it is used in a surface cover layer, the costs for the materials for electric connection members such as connection terminal may increase. In order to address the above problems, it is desired to suppress increase of the friction coefficient on the surface of a metal layer including Sn without using Ag on the surface of an electric connection member such as connection terminal.

An object of the present invention is to provide a metal material and a connection terminal capable of suppressing increase of friction coefficient on the surface of a metal layer including Sn without requiring use of Ag.

### Means to Solve the Problem

In the present disclosure, a metal material includes a substrate and a surface layer which covers the surface of the substrate, the surface layer including Sn and In, at least In being present in the uppermost surface.

A connection terminal of the present disclosure includes said metal material, in which said surface layer is formed on the surface of the substrate at least in a contact portion in which the connection terminal electrically contacts a counterpart conductive member.

### Effect of the Invention

The metal material and the connection terminal according to the present disclosure are capable of suppressing increase of the friction coefficient on the surface without requiring use of Ag.

### BRIEF DESCRIPTION OF THE DRAWINGS

FIGS. 1A and 1B are diagrams that schematically illustrate a configuration of a metal material according to an embodiment of the present disclosure. FIG. 1A is a cross section of a laminated structure of the metal material. FIG. 1B is a plan view illustrating a state of a surface of the metal material.

FIG. 2 is a cross section of a connection terminal according to an embodiment of the present disclosure.

FIGS. 3A to 3D are reflected scanning electron microscope (SEM) images of a surface of samples A1 to A4, respectively.

FIGS. 4A to 4D are diagrams that illustrate the element distribution obtained by energy dispersive x-ray spectroscopy (EDX) on the surface of the sample A2. FIGS. 4A to 4C illustrate the distribution of Sn, Cu, In, respectively. FIG. 4D illustrates the distribution of In illustrated in FIG. 4C in the scale of 0-30% by mass. In the gray scale of each of FIGS. 4A to 4D, the numerical values are enlarged and indicated for every 10 notches. In each of FIGS. 4A to 4D, the scale for the length corresponds to 3 μm.

FIGS. 5A to 5E are diagrams illustrating measurement results for the friction coefficient for samples A1 to A4 and A0, respectively.

FIGS. 6A to 6C are diagrams illustrating measurement results for the friction coefficient for samples B1, B2, and B0, respectively.

FIGS. 7A to 7D are diagrams illustrating measurement results for the friction coefficient for samples C1 to C3 and A0, respectively.

### DETAILED DESCRIPTION TO EXECUTE THE INVENTION

To begin with, characteristics of an embodiment of the present disclosure will be enumerated and described.

A metal material according to the present disclosure includes a substrate and a surface layer covering the surface of the substrate; the surface layer includes Sn and In; and at least In exists on the uppermost surface.

The metal material according to the present disclosure includes a surface layer which covers the surface of the substrate and includes Sn and In, in which at least In is exposed on the uppermost surface. In is a highly soft metal which exerts solid lubricity; and with In exposed on the uppermost surface of the surface layer, the friction coefficient of the surface of the metal material can be decreased thanks to the solid lubricating function. Contrary to cases of using Ag, the friction coefficient hardly increases due to adhesion of In itself. With the configuration including a surface layer which includes In as well as Sn, the present disclosure is capable of suppressing increase of friction coefficient that may occur due to adhesion of Sn on the surface of a metal material without using Ag. Contrary to Ag, In does not get discolored by sulfurization; and In can be used at costs lower than those required for cases of using Ag.

In the present embodiment, it is preferable if at least a part of In be in a state of In—Sn alloy. An In—Sn alloy is formed in the surface layer including Sn and In as a stable alloy, thus enabling the state in which In is exposed on the uppermost surface to be stably maintained.

In this configuration, it is preferable if the In—Sn alloy include InSn₄. With this configuration, InSn₄ is easily and stably formed in the surface layer containing Sn and In as an intermetallic compound and exerts a high effect of suppressing increase of the friction coefficient. Thus, with the In—Sn alloy including InSn₄, the present embodiment is capable of effectively suppressing increase of the friction coefficient with a small amount of In.

It is preferable if the surface layer contain Sn include an Sn-rich portion in which the concentration of In is lower than the concentration of Sn an In-rich portion in which the concentration of In is higher than the concentration of In in said Sn-rich portion; and both the Sn-rich portion and the In-rich portion be exposed onto the uppermost surface. With the In-rich portion of the surface layer containing In at a high concentration, the effect of suppressing increase of the friction coefficient can be sufficiently exerted even if the In-rich portion is not exposed on the entire uppermost surface and is exposed in coexistence with the Sn-rich portion in which the concentration of In is low.

In this configuration, it is preferable if the In-rich portion include an In—Sn alloy. With this configuration including the In—Sn alloy formed in the In-rich portion, the state in which the In-rich portion is exposed onto the uppermost surface can be stably maintained and thus the In-rich portion is allowed to contribute to the suppression of increase of the friction coefficient.

On the other hand, it is preferable if the Sn-rich portion include an alloy of the metallic element constituting the substrate and Sn. In this configuration, the In-rich portion of the surface layer is allowed to coexist with the Sn-rich portion formed as an alloy of the metal element constituting the substrate and Sn; thus, the entire surface layer is capable of exerting the effect of suppressing increase of the friction coefficient.

It is preferable if the area ratio of the In-rich portion in the uppermost surface of the surface layer be higher than 50%. With the configuration in which the In-rich portion occupies a large area and is exposed onto the uppermost surface of the surface layer, the effect of suppressing increase of the friction coefficient exerted by the In-rich portion can be increased.

On the other hand, it is preferable if the ratio of the area occupied by the In-rich portion on the uppermost surface of the surface layer be 90% or less. This is because if the In-rich portion is exposed onto the uppermost surface at the area ratio exceeding 90%, the effectiveness of the contribution of the In-rich portion occupying the large area to the suppression of increase of the friction coefficient does not increase. In addition, with the configuration in which the area ratio of the In-rich portion of 90% or less, a phenomenon of even decreased effect of suppression of increase of the friction coefficient can be more easily prevented, which may occur due to the low concentration of In included in the In-rich portion if the area ratio of the In-rich portion is too high.

It is preferable if the concentration of In on the uppermost surface of the surface layer be 10% or more in atomic percentage. With this configuration, the effect of suppression of increase of the friction coefficient on the uppermost surface of the metal material imparted by In can be more easily exerted.

It is preferable if the content of In in the surface layer be 1% or more in an atomic ratio in relation to Sn. With this configuration in which a sufficient amount of In is included in the surface layer and exposed onto the uppermost surface, it becomes easier to increase the effect of suppressing increase of the friction coefficient imparted by In.

On the other hand, it is preferable if the content of In in the surface layer be 25% or less in an atomic ratio in relation to Sn. With this configuration, a phenomenon of In not being able to effectively contribute to the suppression of increase of the friction coefficient that may occur if the content of In is too high can be easily prevented.

It is preferable if In be distributed in the surface layer in a region with the depth of at least 0.01 μm from the uppermost surface. With this configuration, the effect of suppression of increase of the friction coefficient on the uppermost surface of the metal material imparted by In can be more easily exerted.

It is preferable if the surface of the substrate include at least one of Cu and Ni. Metal materials including at least one of Cu and Ni have been commonly used as a substrate constituting an electric connection member such as connection terminal; and even if Cu and Ni are distributed over the surface layer including Sn and In and form an alloy with Sn or In, the effect of suppressing increase of the friction coefficient imparted by In included in the surface layer is maintained.

The connection terminal according to the present disclosure includes the metal material, in which said surface layer is formed on the surface of the substrate in the contact portion in which the connection terminal electrically contacts a counterpart conductive member. In the connection terminal described above, Sn and In described above are contained and the surface layer in which In is exposed on the uppermost surface is formed at least in the contact portion; and with this configuration, the present embodiment can suppress the increase of the friction coefficient in the contact portion that may occur when the connection terminal is slid at a location between the connection terminal and the counterpart thereof without using Ag. Without the use of Ag, the present embodiment is capable of suppressing discoloration of the connection terminal and increase of the material cost.

It is preferable if a metal including Sn be exposed on the surface of the counterpart conductive member. According to the present disclosure including the connection terminal in which In is exposed onto the uppermost surface of the contact portion as well as Sn, increase of the friction coefficient can be effectively suppressed by the adhesion of Sn atoms that occurs during sliding of the connection terminal even if Sn is exposed on the surface of the counterpart conductive member.

### DETAILED DESCRIPTION OF EMBODIMENT

An embodiment of the present disclosure will be described in detail below with reference to the attached drawings. The content (concentration) of each element will be described herein in the unit of atomic ratio such as atomic percentage unless otherwise noted. In addition, an element metal herein also includes a metal containing inevitable impurities. An alloy herein also includes alloys in the form of solid solution and alloys constituting an intermetallic compound unless otherwise noted. Further, an alloy including a specific metal as primary component herein refers to an alloy with a composition in which the content of the metal element is 50% or more in atomic percentage.

<Metal Material>

The metal material according to an embodiment of the present disclosure includes a lamination of metal material. The metal material according to an embodiment of the present disclosure may constitute any metal member and can be suitably used as a material constituting an electric connection member such as connection terminal.

(Configuration of the Metal Material)

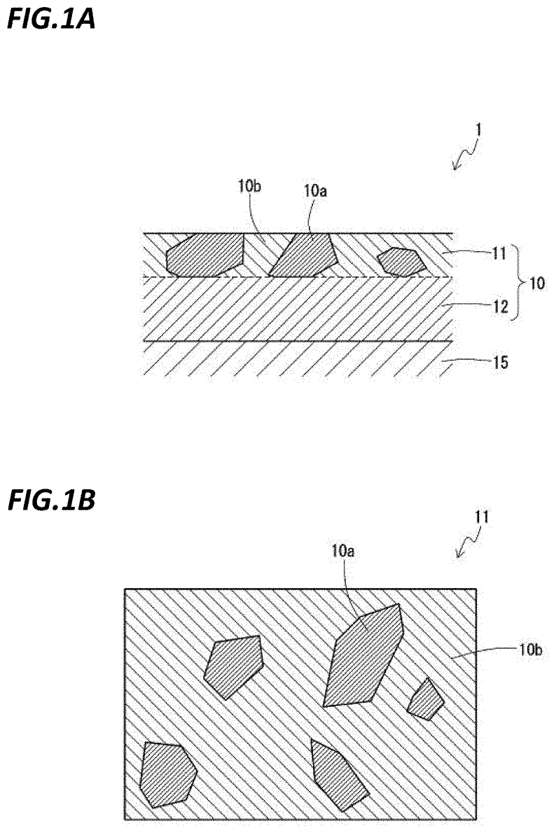

FIGS. 1A and 1B illustrate an example of configuration of a metal material 1 according to an embodiment of the present disclosure. The metal material 1 includes a substrate 15 and a surface layer 10 formed on the surface of the substrate 15 and exposed onto the uppermost surface. Within the scope not impairing the characteristics of the surface layer 10, a thin film such as an organic layer (not illustrated) may be arranged on top of the surface layer 10 exposed on the uppermost surface of the metal material 1.

(1) Description of the Substrate

The substrate 15 may include a metal material with an arbitrary shape such as a shape of a plate. The material included in the substrate 15 is not particularly limited; if the metal material 1 constitutes an electric connection member such as connection terminal, Cu or a Cu alloy, Al or an Al alloy, Fe or an Fe alloy, and the like can be suitably used as the material constituting the substrate 15. Among them, Cu or a Cu alloy having high electric conductivity can be particularly suitably used.

On the surface of the substrate 15, i.e., between the substrate 15 and the surface layer 10, an intermediate layer (not illustrated) including a metal layer thinner than the substrate 15 may be arranged in contact with the surface of the substrate 15. If an intermediate layer is arranged on the surface of the substrate 15, the intermediate layer is herein regarded as a part of the substrate 15. In other words, if an intermediate layer is arranged, the metal material included in the intermediate layer constitutes the surface of the substrate 15. With the configuration in which the intermediate layer is arranged on the surface of the substrate 15, an effect of improving the adhesion between the substrate 15 and the surface layer 10 and an effect of suppressing mutual dispersion of the structural elements that may occur between the substrate 15 and the surface layer 10 can be obtained. Examples of the material included in the intermediate layer include a metal material containing at least one selected from the group consisting of Ni, Cr, Mn, Fe, Co, and Cu (group A). The material included in the intermediate layer may be either an element metal constituted by one selected from the group A or an alloy containing one or more metal elements selected from the group A. It is particularly preferable if the intermediate layer include Ni or an alloy including Ni as the primary component. In the intermediate layer, a part of the layer close to the substrate 15 may form an alloy with the structural element of the substrate 15 and another part close to the surface layer 10 may form an alloy with the structural element of the surface layer 10.

It is preferable if the metal material constituting the surface of the substrate 15, i.e., the metal material which constitutes the substrate 15 itself if no intermediate layer is arranged and the metal material which constitutes the intermediate layer if an intermediate layer is arranged include at least one of Cu and Ni. It is particularly preferable if such a material include a Cu element or an Ni element or an alloy including Cu or Ni as a primary component. This is because even if Cu and Ni are to be diffused over the surface layer 10 and further form an alloy with the structural element of the surface layer 10, the characteristics of the surface layer 10 described in detail below would not be easily impaired. In a configuration in which the substrate 15 includes Cu or a Cu alloy, the necessity for arranging an intermediate layer including Ni or an Ni alloy to suppress dispersion of Cu over to the surface layer 10 is low because the characteristics of the surface layer 10 would not be easily impaired by Cu originated in the substrate 15; and in this configuration, it is preferable if the intermediate layer be omitted for simpler configuration of the metal material 1.

(2) Description of the Surface Layer

The surface layer 10 is configured as a metal layer containing Sn and In. The surface layer 10 may contain an element other than Sn and In; to prevent the configuration formed by Sn and In and the characteristics expressed by Sn and In from being impaired, it is preferable if the surface layer 10 include a material containing Sn and In as main components, i.e., a material with a ratio of 50% or more in atomic percentage in the entire surface layer 10 as the total of Sn and In. A configuration is particularly preferable if the surface layer 10 include Sn and In only except for inevitable impurities contained therein, altered components altered by phenomena such as oxidation, carbonization, and nitrization that may occur at locations close to the surface, and components existing in the environment adhered to the surface. Note that it is preferable if the surface layer 10 do not contain Ag, in particular. This is because Ag is highly adhesive; is likely to increase the friction coefficient for the surface layer 10; easily gets sulfurized and discolored; and increases the material cost for the surface layer 10.

The distribution of Sn and In on and within the surface layer 10 is not limited to a particular distribution state as far as at least In atoms exist on the uppermost surface. In addition, Sn and In respectively may be in the state of element metal or exist in the form of an alloy. Portions including the element metal and other portions including an alloy may coexist in the surface layer 10. As will be described in detail below, with the configuration in which In is exposed onto the uppermost surface and included in the surface layer 10 in this state, the present embodiment is capable of achieving the effect of suppressing increase of the friction coefficient in the surface layer 10.

In is a metal which easily forms an alloy with Sn; thus, In easily forms an In—Sn alloy if the surface layer 10 is configured to include lamination of an Sn layer and an In layer as described below. To maintain the stability for the state of the surface layer 10, it is preferable if at least a part of In contained in the surface layer 10, more preferably most of In contained in the surface layer 10, constitute an In—Sn alloy. For example, as will be described in the Example below, it is preferable if the total quantity detected by the x-ray diffractometry (XRD) as a phase including In include an In—Sn alloy except for inevitable impurities. The form of the In—Sn alloy may be a solid solution or an intermetallic compound; and it is more preferable if the In—Sn alloy form an intermetallic compound for the stability of the surface layer 10 and other factors.

Examples of the composition of the In—Sn intermetallic compound that can be included in the surface layer 10 include compounds such as InSn₄ and In₃Sn. The In—Sn alloy contained in the surface layer 10 preferably includes one or more selected from these intermetallic compounds. Considering the stability of the In—Sn alloy and to obtain a high effect from In included in the surface layer 10 by a small amount described below, it is preferable if the surface layer 10 contain InSn₄ among the compounds mentioned above. Further, it is preferable if the total quantity detected by XRD of In contained in the surface layer 10 be InSn₄ except for the inevitable impurities. InSn₄ is an intermetallic compound having a β-tin structure.

The entire surface layer 10 may consist of a homogeneous In—Sn alloy. However, to form a portion of the surface layer 10 with the concentration of In higher than the In concentration in other portions and exert a high effect of In contained in the surface layer 10 such as suppression of increase of friction coefficient in the surface layer 10 with the high In-concentration portion, it is more preferable if two phases including a Sn-rich portion 10a having a relatively high Sn concentration and an In-rich portion 10b having a relatively high In concentration be included in coexistence as illustrated in FIGS. 1A and 1B. With the configuration in which In is distributed in the In-rich portion 10b at a high concentration, the effect imparted by In contained in the surface layer 10 can be highly effectively exerted in the In-rich portion 10b, and this high effect can be easily and effectively used as one of the characteristics of the entire surface layer 10. The present embodiment will be described below mainly referring to the configuration in which the Sn-rich portion 10a and the In-rich portion 10b coexist in the surface layer.

As will be described below, in a configuration in which the Sn layer and the In layer are laminated in this order, an Sn alloy and/or an In alloy are appropriately generated and the surface layer 10 including the alloy is formed, the Sn-rich portion 10a and the In-rich portion 10b are easily formed in a portion close to the uppermost surface of the surface layer 10, i.e., in an upper layer 11, and a lower layer 12 constituted substantially be Sn is easily formed below the upper layer 11 (in a portion close to the substrate 15). In this configuration, both the upper layer 11 and the lower layer 12 are included in the surface layer 10; and the lower layer 12 formed in this configuration can be regarded as an Sn-rich portion because it is a phase having a high Sn concentration. However, the lower layer 12 formed below the upper layer 11 including the Sn-rich portion 10a and the In-rich portion 10b will be herein not referred to as an Sn-rich portion to distinguish the same from the Sn-rich portion 10a of the upper layer 11 unless otherwise noted.

(2-1) Sn-Rich Portion

The Sn-rich portion 10a is a phase which contains Sn, in which the concentration of In is lower than the concentration of Sn. The state in which the concentration of In is lower than the concentration of Sn refers to a state in which the content of In is lower than the content of Sn in an atomic ratio, including a configuration which the Sn-rich portion 10a contains no In. Specific examples of the Sn-rich portion 10a include: (i) a configuration in which the Sn-rich portion 10a is constituted by Sn in single substance state (a configuration in which the Sn-rich portion 10a is constituted by Sn and inevitable impurities only); (ii) a configuration in which the Sn-rich portion 10a is constituted by an In—Sn alloy containing In by an amount smaller than the amount of Sn; (iii) a configuration in which the Sn-rich portion 10a is constituted by a metal element other than In and Sn; and (iv) a configuration in which the Sn-rich portion 10a is constituted by an alloy of In in an amount smaller than Sn, a metal element other than In, and Sn. The Sn-rich portion 10a may include one of the above configurations only, or alternatively, may include two or more portions with different configurations and compositions.

Examples of the metal element other than In, which is included in the Sn-rich portion 10a and forms an alloy with Sn in the configurations (iii) and (iv) described above include a metal element (substrate element) which constitute the substrate 15. If the substrate element is diffused in the surface layer 10, the substrate element may be kept in the Sn-rich portion 10a as an alloy with Sn so that the In-rich portion 10b does not contain the substrate element or the concentration of the substrate element in the In-rich portion 10b is maintained at a low level; and with this configuration, it becomes easier for In contained in the In-rich portion 10b to exert its essential characteristic. In addition, in this configuration, the stability of the In-rich portion 10b which enables the characteristics of In to be easily exerted can be maintained. To maintain the high concentration of In in the In-rich portion 10b, it is preferable if the Sn-rich portion 10a include Sn in single substance state or an alloy of Sn with the substrate element or both of them as a whole and include substantially no In. In the configuration in which the lower layer 12 consisting of Sn is formed below the upper layer 11 including the Sn-rich portion 10a, the Sn-rich portion 10a of the upper layer 11 may be arranged in continuation with the lower layer 12; and further, the compositions may continuously change between the Sn-rich portion 10a and the lower layer 12.

In a configuration in which Cu is included in the surface of the substrate 15 (a surface of the substrate 15 in the configuration in which no intermediate layer is formed, or a surface of the intermediate layer in the configuration in which an intermediate layer is formed), it is preferable if the Sn-rich portion 10a include a Cu—Sn alloy. It is more preferable if the total quantity of Sn detected by XRD among the Sn contained in the surface layer 10 be Sn in single substance state or a Cu—Sn alloy except for the inevitable impurities. In this configuration, the surface layer 10 may be easily configured in which the lower layer 12 is constituted by an Sn element and the Sn-rich portion 10a included in the upper layer 11 is constituted by a Cu—Sn alloy. Examples of the composition of the Cu—Sn alloy constituting the Sn-rich portion 10a include Cu₆Sn₅. In the configuration including the Sn-rich portion 10a constituted by a Cu—Sn alloy such as Cu₆Sn₅, the characteristic exerted by the In-rich portion 10b coexisting with the Sn-rich portion 10a hardly gets impaired.

(2-2) In-Rich Portion

The In-rich portion 10b contains In at a concentration higher than the concentration of In in the Sn-rich portion 10a. In other words, the atomic concentration of In in the composition is higher than the Sn-rich portion 10a in the In-rich portion 10b. Specific examples of the configuration of the In-rich portion 10b include: (i) a configuration in which the In-rich portion 10b is constituted by In as an element (a configuration in which the In-rich portion 10b is constituted by In and inevitable impurities only); (ii) a configuration in which the In-rich portion 10b is constituted by an In—Sn alloy; (iii) a configuration in which the In-rich portion 10b is constituted by a metal element other than Sn and In; and (iv) a configuration in which the In-rich portion 10b is constituted by an alloy of Sn and In and other metal elements such as substrate element. Note that in the configuration in which the In-rich portion 10b is constituted by an alloy including Sn as in the configurations (ii) and (iv) described above, the relationship between the In-rich portion 10b and the Sn-rich portion 10a for the concentration of Sn is not particularly limited as long as the concentration of In is higher for the In-rich portion 10b compared with the Sn-rich portion 10a. The In-rich portion 10b may include one of the above configurations (i) to (iv) described above only, or alternatively, may include two or more portions with different configurations and compositions.

To allow the In-rich portion 10b capable of strongly exerting the characteristic exerted by In to stably coexist with the Sn-rich portion 10a and for other purposes, it is preferable if the In-rich portion 10b include an In—Sn alloy. It is more preferable if the total quantity of In contained in the surface layer 10 detected by XRD except for the inevitable impurities form an In—Sn alloy and constitute the In-rich portion 10b. Examples of the In—Sn intermetallic compound constituting the In-rich portion 10b include compounds such as InSn₄ and In₃Sn mentioned above. It is preferable if the In-rich portion 10b include InSn₄ among these intermetallic compounds. It is particularly preferable if the total quantity of In included in the In-rich portion 10b be InSn₄ except for the inevitable impurities. This is because InSn₄ has a high stability and exerts a high effect obtained by In included in the surface layer 10 such as the effect of suppressing increase of the friction coefficient in the surface layer 10 even if a small amount of In is contained.

(2-3) Distribution of the Sn-Rich Portion and the In-Rich Portion

In the configuration in which the surface layer 10 includes the Sn-rich portion 10a and the In-rich portion 10b, the spatial distribution of the Sn-rich portion 10a and the In-rich portion 10b is not particularly limited if at least In atoms exist on the uppermost surface. As an exemplary configuration, a laminated structure can be employed in which the Sn-rich portion 10a is formed on the surface of the substrate 15 as a layer and the In-rich portion 10b constituted by In element or an In—Sn alloy is arranged on the surface of the layer of the Sn-rich portion 10a.

However, to form the In-rich portion 10b containing In at a high concentration and capable of strongly exerting the characteristic imparted by In and effectively use the characteristic imparted by In as the characteristic of the entire surface layer 10, it is preferable if the Sn-rich portion 10a and the In-rich portion 10b coexist in the surface layer 10 in a mixed state instead of being separated in layers, as illustrated in FIGS. 1A and 1B. In this configuration, at least the In-rich portion 10b may be exposed onto the uppermost surface of the surface layer 10. It is more preferable if both the In-rich portion 10b and the Sn-rich portion 10a are exposed onto the uppermost surface of the surface layer 10.

In the configuration in which the Sn-rich portion 10a and the In-rich portion 10b coexist in the surface layer 10 in a mixed state, the shapes and the mutual arrangement of the Sn-rich portion 10a and the In-rich portion 10b that coexist in a mixed state are not particularly limited. However, as will be described below, in a configuration in which the Sn layer and the In layer are laminated in this order to form the surface layer 10, it is easy to achieve a configuration including the Sn-rich portion 10a distributed in the In-rich portion 10b in an islands-like manner as illustrated in FIGS. 1A and 1B. In this configuration, it is preferable if both the Sn-rich portion 10a distributed in an island-like state and the In-rich portion 10b surrounding the Sn-rich portion 10a be exposed onto the uppermost surface of the surface layer 10.

In the configuration in which the Sn-rich portion 10a and the In-rich portion 10b coexist and both of them are exposed on the uppermost surface of the surface layer 10, the dimension of the area of exposure of each of the respective the Sn-rich portion 10a and the In-rich portion 10b onto the uppermost surface as a continuous area is not particularly limited. However, to effectively exert the characteristic obtained by the In-rich portion 10b, it is preferable if the length of the Sn-rich portion 10a segmenting the continuous In-rich portion 10b (segmentation length) be short. In the configuration in which the Sn-rich portion 10a is distributed in the In-rich portion 10b in an islands-like manner as illustrated in FIGS. 1A and 1B, the longitudinal diameter of the Sn-rich portion 10a (the length of a straight line that is the longest of the straight lines crossing the Sn-rich portion 10a) can be regarded as the segmentation length. For effective exertion of the characteristic obtained by the In-rich portion 10b and suppression of spatial heterogeneity of the characteristic on the uppermost surface of the surface layer 10, the segmentation length is preferably 10 μm or less. On the other hand, also for effective exertion of the characteristic obtained by the Sn-rich portion 10a, the segmentation length is preferably 0.5 μm or more.

In the configuration in which both the Sn-rich portion 10a and the In-rich portion 10b are exposed onto the uppermost surface of the surface layer 10, the ratio of area of the uppermost surface occupied by the In-rich portion 10b is preferably higher than 50%. The area ratio of the In-rich portion 10b can be defined as a ratio of area of exposure of the In-rich portion 10b to the area of the entire uppermost surface ([area of exposure of the In-rich portion]/[area of the entire uppermost surface]×100%). With the configuration in which the area ratio of the In-rich portion 10b is higher than 50%, i.e., the area of exposure of the In-rich portion 10b is higher than the area of exposure of the Sn-rich portion 10a, the characteristic obtained by the In-rich portion 10b such as the effect of suppressing increase of the friction coefficient can be strongly exerted as the characteristic of the entire uppermost surface of the surface layer 10. For more effective exertion of the characteristic obtained by the In-rich portion 10b, it is preferable if the area ratio of the In-rich portion 10b be 55% or more; it is particularly preferable if the area ratio of the In-rich portion 10b be 70% or more.

On the other hand, the area ratio of the In-rich portion 10b is not particularly limited by any upper limit; and if the area ratio of the In-rich portion 10b is 90% or less, the characteristic obtained by the In-rich portion 10b can be sufficiently exerted in the surface layer 10. In addition, if the concentration of In in the surface layer 10 is relatively low and if the area ratio of the In-rich portion 10b is too high, the concentration of In in each part of the In-rich portion 10b becomes low, and the effectiveness of the effect of In exerted in the In-rich portion 10b may adversely become low. Particularly in a configuration in which Cu is contained in the surface of the substrate 15 described in the Example below where the concentration of In in the entire surface layer 10 is low, the area ratio of the In-rich portion 10b may become high depending on the material for the substrate 15. In such a configuration, the high area ratio of the In-rich portion 10b means that the concentration of In in the surface layer 10 is low. In other words, the concentration of In in the In-rich portion 10b becomes low due to the influence from both the large area occupied by the In-rich portion 10b and the small amount of In contained in the surface layer 10, and it thus becomes difficult for the characteristic imparted by In to be exerted. In this configuration, for prevention of low concentration of In in the In-rich portion 10b, it is preferable if the area ratio of the In-rich portion 10b be controlled to 90% or less. It is particularly preferable if the area ratio of the In-rich portion 10b be 80% or less. The area ratio of the In-rich portion 10b can be computed by measuring the area of the In-rich portion 10b with a microscopic image showing the distribution of the phases in the uppermost surface of the metal material 1, such as elemental distribution or other distribution data obtained by energy dispersive x-ray spectroscopy (EDX) which uses a scanning electron microscope (SEM).

(2-4) Content of In

The ratios of content of In and Sn in the surface layer 10 may be appropriately set in accordance with the desired characteristic of the surface layer 10; and for effective exertion of the characteristic imparted by In such as suppression of increase of the friction coefficient, it is preferable if the content of In as the amount contained in the entire surface layer 10 be 1% or more in atomic percentage in relation to Sn (In [at %]/ Sn [at %]). To achieve more effectiveness of exertion of the characteristic imparted by In, it is particularly preferable if the content of In in the surface layer 10 be 5% or more in an atomic ratio to Sn, more preferably 10 atomic % or more. In the configuration in which the surface layer 10 is constituted by the upper layer 11 and the lower layer 12 as illustrated in FIG. 1A or more than two layers with different compositions, the content of each of In and Sn herein refers to the total quantity of In or Sn contained in the entire surface layer 10 as a total In or Sn content for all the layers constituting the surface layer 10.

On the contrary, if the content of In in the surface layer 10 is too high, the effect such as effect of suppressing increase of the friction coefficient imparted by In may not improve; and it is thus preferable if the content of In in the surface layer 10 be controlled to 25% or less in an atomic ratio to Sn. In particular, as described above, the area ratio of the In-rich portion 10b tends to be higher for less content of In in the entire surface layer 10 in some configurations, and in such a configuration, if the content of In in the surface layer 10 is too high, the area ratio of the In-rich portion 10b may become low, and thus the effect of suppressing increase of the friction coefficient imparted by In contained in the surface layer 10 may become adversely low. In such a configuration, to secure a sufficient area ratio of the surface layer 10, it is preferable if the content of In in the surface layer 10 be controlled to 25% or less in an atomic ratio to Sn. It is more preferable if the content of In be 20% or less in an atomic ratio to Sn, more preferably 15% or less. In the present embodiment, the content of In in the surface layer 10 can be computed by performing elemental analysis in the surface layer 10 by a method such as x-ray fluorescence spectrometry. Alternatively, if the thickness of the Sn layer and the In layer used as the raw material in preparing the surface layer 10 is known, the content of In in the surface layer 10 can be computed by converting the thickness of each such raw material layer into an atomic ratio based on the density of Sn and In.

As described above, for higher effect of suppressing increase of the friction coefficient in the uppermost surface, it is preferable if In be distributed at a concentration higher in a region close to the surface including the uppermost surface among regions in the depth direction (e.g., in the upper layer 11) than the concentration of In in a deeper region (e.g., the lower layer 12). It is preferable if In be distributed in regions of the surface layer 10 with the depth of at least 0.01 μm. It is more preferable if In be distributed in regions of the surface layer 10 with the depth of at least 0.05 μm, yet more preferably in regions of the surface layer 10 with the depth of at least 0.1 μm. The concentration of In in the uppermost surface (the ratio of In to all the elements present in the uppermost surface in an atomic ratio) is preferably 10% or more, more preferably 15% or more. Yet more preferably, In may be contained at the concentration described above in regions up to the depth deep enough to be determined by detecting electrons emitted in the uppermost surface by a method such as x-ray photoelectron spectroscopy (XPS) and Auger electron spectroscopy (AES). In a typical configuration, it is preferable if In at the concentration mentioned above be contained in regions up to the depth of about 5 nm from the uppermost surface.

The thickness of the entire surface layer 10 is not particularly limited and may be a thickness of which the characteristic imparted by Sn and In can be sufficiently exerted. For example, the thickness of the surface layer 10 is preferably 0.05 μm or more, more preferably 0.1 μm or more. On the other hand, to prevent forming of an excessively thick surface layer 10, the thickness of the surface layer 10 may be 10 μm or less.

(Surface Characteristics of the Metal Material)

According to the present embodiment, the metal material 1 includes In in the uppermost surface of the surface layer 10 which includes both Sn and In as described above. Accordingly, the characteristic imparted by In is exerted in the surface layer 10 as well as the characteristic imparted by Sn.

Sn has been conventionally and commonly used to cover the surface of a metal material constituting an electric connection member such as connection terminal. Because Sn has a high conductivity and is capable of easily breaking oxide films existing on a surface, it has a low contact resistance and imparts high electric connection characteristic on a surface of a metal material. Sn also has a high corrosion resistance and solder wettability. According to the present embodiment, the surface layer 10 of the metal material 1 includes Sn, and thus the electric connection characteristic, corrosion resistance, and solder wettability of the surface layer 10 are high.

Sn has excellent electric connection characteristics as described above, however, on the other hand, easily causes the friction coefficient when the metal material 1 is slid against a counterpart metal member or other member due to adhesion and digging-up that may occur on the surface of Sn during the sliding. On the contrary, In is a metal softer than Sn and has a high solid lubricity. In the present embodiment, the surface layer 10 includes In having solid lubricity as described above and In is exposed onto the uppermost surface of the surface layer 10, and thus the solid lubricity of In can be exerted on the surface of the surface layer 10. Thanks to the solid lubricity of In, the present embodiment is capable of suppressing the increase of friction coefficient that may occur due to adhesion and digging-up of Sn in the surface layer 10. The solid lubricity of the In can be exerted even if In exists in the form of an alloy with other metal element such as Sn. Also in a configuration in which the Sn-rich portion 10a is exposed on the uppermost surface in the surface layer 10 as well as the In-rich portion 10b, the In-rich portion 10b exerts the effect of suppressing increase of the friction coefficient, and thus the friction coefficient can be controlled to be low for the entire surface layer 10.

In is a metal susceptible to oxidation, however, as Sn is, In is capable of easily breaking an oxide film on a surface when loads are applied. Accordingly, as Sn does, In also imparts a low contact resistance in the surface layer 10 and does not impair the high electric contact characteristic imparted by Sn. With this configuration, a contact resistance as low as that in a metal layer including Sn element can be obtained in the surface layer 10. Further, Sn forms an alloy with In and the melting point becomes lower than that for Sn element, thus the metal material 1 constituted by the alloy becomes softer compared with a configuration in which the metal material 1 is constituted by Sn element, and thereby the easiness in breaking oxide films on a surface may improve in some configurations. As a result, the contact resistance in the surface layer 10 containing Sn and In may become further lower than that in a metal layer constituted by Sn element.

As described above, in a configuration in which the surface layer 10 contains In as well as Sn and the In is exposed onto the uppermost surface, increase of friction coefficient in the metal material 1, which may occur due to the adhesion of Sn, can be suppressed with the solid lubricity of In. Further, the high electrical connection characteristic imparted by Sn does not get impaired and can be further improved in some configurations. Unlike Ag used in Patent Document 1 for covering an Sn-based surface layer, In is a metal with low adhesion, and hardly causes increase of friction coefficient even if the metal material constituted by In is repeatedly slid. In addition, unlike Ag, In does not get discolored by sulfurization; and further, In can be used at relatively low cost. For these reasons, the metal material 1 according to the present embodiment including the surface layer 10 containing In can be suitably used as a component for electric connection members such as connection terminals to which friction is applied by sliding or other operations.

The distribution of Sn atoms and In atoms is not particularly limited as long as at least In atoms are distributed on the uppermost surface of the surface layer 10, and it is preferable if the Sn-rich portion 10a and the In-rich portion 10b mixedly coexist in the surface layer 10 and both portions be exposed onto the uppermost surface. In this configuration, In contained in the surface layer 10 is concentrated in the In-rich portion 10b; and the surface characteristic imparted by In such as suppression of friction coefficient can be more intensely exerted in the In-rich portion 10b compared with a configuration in which In is thinly distributed over the entire surface layer 10.

Alloying of In and Sn easily progress; and thus, it is preferable if at least a part of, more preferably the total quantity of In contained in the surface layer 10 as the In-rich portion 10b or other portions excluding the inevitable impurities form an In—Sn alloy such as InSn₄. With the In—Sn alloy formed in the above-described manner, it becomes easy to maintain the stable state of the surface layer 10 such as a state in which the Sn-rich portion 10a and the In-rich portion 10b coexist in the surface layer 10. It becomes easier to maintain the stable state of the surface layer 10 in which the Sn-rich portion 10a and the In-rich portion 10b coexist if Sn in the Sn-rich portion 10a exists in the form of an alloy with other metals such as substrate element. As will be described below, in a configuration in which the Sn-rich portion 10a is constituted by an alloy of a substrate element such as Cu and Ni and Sn, such an Sn-rich portion 10a does not considerably impair the effect of suppressing increase of the friction coefficient or the effect of suppressing the contact resistance and is capable of imparting characteristics for the entire surface layer 10 such as low friction coefficient and low contact resistance.

In the present embodiment, the surface layer 10 contains In as well as Sn and at least In is exposed onto the uppermost surface, thus increase of friction coefficient that may occur as sliding against a counterpart metal material on which an Sn layer is formed on the uppermost surface as will be described below in the Example progress can be suppressed. The value for the friction coefficient can be controlled to be a value in a low-value range such as 0.4 or less, or further, 0.3 or less. At the same time, the contact resistance can be controlled within a range of 120% compared with a configuration in which an Sn layer not including In only is formed. In another configuration, the contact resistance can be controlled to 100% or less, i.e., a value smaller than that in a configuration in which an Sn layer only is formed.

As described above, the metal material 1 according to the present embodiment can control the increase of friction coefficient in the surface of the surface layer 10 and is further capable of achieving a low contact resistance. With the configuration described above, the metal material 1 can be suitably used for use as an electric connection member such as connection terminal, in particular, which contacts a counterpart conductive member in the surface of the surface layer 10.

(Production Method of the Metal Material)

The metal material 1 according to the present embodiment can be produced by forming the surface layer 10 on the surface of the substrate 15 after appropriately forming an intermediate layer by plating or other methods.

The production method of the surface layer 10 is not particularly limited, and the surface layer 10 can be formed by a method such as evaporation method and immersion method. In producing the surface layer 10, the surface layer 10 containing Sn and In may be formed by one process such as eutectoid reaction between Sn and In; and for easier production, it is preferable if lamination of an Sn layer and an In layer be formed and then alloying between Sn and In be appropriately advanced to form the surface layer 10. An immersion method is suitable for a method of forming a thin In layer; while an electroplating method is suitable for forming a relatively thick In layer.

Further, heating may be appropriately carried out after the Sn layer and the In layer are laminated. As will be described in the Example below, however, the effect of suppressing the increase of friction coefficient can be obtained regardless of whether the heating is carried out or not. However, the heating advances the alloying between In and Sn, making it easier to form a configuration in which the In-rich portion 10b surrounds the Sn-rich portion 10a existing in an islands-like manner and these portions are formed as an In—Sn alloy, as illustrated in FIGS. 1A and 1B. In addition, if the heating is used in this configuration, reflow treatment for Sn advances in the Sn-rich portion 10a and thus effects such as prevention of whisker from occurring can be operated. By carrying out the heating in the state in which the Sn layer and the In layer are laminated as described above, formation of the In-rich portion 10b and the reflow treatment for the Sn-rich portion 10a can be performed at the same time by one heating process, with the In alloy. If the heating is not performed in the state in which the In layer and the Sn layer are laminated, the In layer may be formed after performing the reflow treatment for the Sn layer before the In layer is formed.

The order of the lamination of the Sn layer and the In layer is not particularly limited, however, if the Sn layer is first formed and then the In layer is laminated onto the surface of the thus formed Sn layer, it becomes easier for In to be exposed on the uppermost surface of the surface layer 10 in a form such as the In-rich portion 10b or the like. The thickness of each of the Sn layer and the In layer and the ratio between the thickness of the Sn and the In layers may be appropriately chosen in accordance with the desired factors such as the thickness and the component composition of the surface layer 10; and examples of the suitable configuration for the Sn layer includes a configuration in which the thickness of the Sn layer is 0.5 μm or more and 10 μm or less. To have a sufficient amount of In distributed on the uppermost surface of the surface layer 10 to be formed, the thickness of the In layer is preferably 0.1 μm or more, more preferably 0.05 μm or more, yet more preferably 0.01 μm or more. On the contrary, to prevent use of an excessive amount of In, it is preferable if the thickness of the In layer be controlled at 0.5 μm or less, more preferably 0.2 μm or less.

<Connection Terminal>

The connection terminal according to an embodiment of the present disclosure is composed of the metal material 1 according to the embodiment described above, and at least includes the surface layer 10 containing Sn and In, arranged on the surface of the contact portion for electric contact with the counterpart conductive member. The specific shape and the type of connection terminal are not particularly limited.

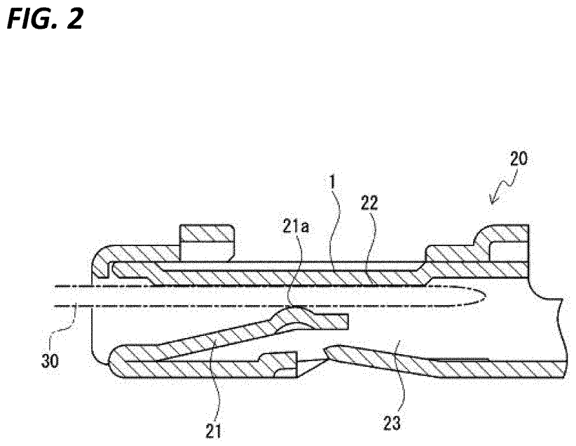

FIG. 2 illustrates a female connector terminal 20 as an example of a connection terminal according to an embodiment of the present disclosure. The female connector terminal 20 has a shape similar to a known fittable female connector terminal. That is, the female connector terminal 20 includes a clamping portion 23 having a tubular shape and an opening in its front portion; and an elastic contactor 21 arranged inside the bottom of the clamping portion 23 and having a shape folded toward the rear of the inside of the clamping portion 23. When a male connector terminal 30 having a shape of a flat plate tab is inserted into the clamping portion 23 of the female connector terminal 20 as the counterpart conductive member, the elastic contactor 21 of the female connector terminal 20 contacts the male connector terminal 30 at an emboss portion 21a swollen toward the inside of the clamping portion 23 to apply an upward force to the male connector terminal 30. The clamping portion 23 includes a ceiling portion including a surface facing the elastic contactor 21 as an inner counter contact surface 22; and when the male connector terminal 30 is pressed by the elastic contactor 21 onto the inner counter contact surface 22, the male connector terminal 30 is pinched and held inside the clamping portion 23.

The entire female connector terminal 20 is composed of the metal material 1 having the surface layer 10 according to the embodiment described above. In this configuration, the surface on which the surface layer 10 of the metal material 1 is formed is oriented toward the inside of the clamping portion 23 and is arranged to form a surface on which the elastic contactor 21 and the inner counter contact surface 22 face each other. As a result, when the male connector terminal 30 is inserted into the clamping portion 23 of the female connector terminal 20 to slide, the effect of suppressing the increase of the friction coefficient exerted by the surface layer 10 is used in the contact portion between the female connector terminal 20 and the male connector terminal 30.

In the present embodiment, the configuration is described above in which the entire female connector terminal 20 is composed of the metal material 1 having the surface layer 10 according to the embodiment described above, and the location of formation of the surface layer 10 is not particularly limited; that is, the surface layer 10 may be formed in any range as long as it is formed at least on the surface of the contact portion for contact with the counterpart conductive member, i.e., on the surface of the inner counter contact surface 22 for contact with the emboss portion 21a of the elastic contactor 21. In addition, the material of the counterpart conductive member such as the male connector terminal 30 is not particularly limited; suitable examples thereof include a material configured so that a metal including Sn is exposed on an uppermost surface. Specifically, similar to the female connector terminal 20, suitable examples thereof include a configuration in which the material for the counterpart conductive member is composed of the metal material 1 having the surface layer 10 according to the embodiment described above and a configuration in which such a material is composed of a metal material including an Sn cover layer constituted by Sn element or an alloy including Sn as its principal component, is formed on its uppermost surface. Even if an Sn cover layer is formed on the uppermost surface of the counterpart conductive member, In is present on the surface of the connection terminal according to the present embodiment, thus adhesion between Sn included in the surface layer 10 and Sn included in the Sn cover layer of the counterpart conductive member is caused due to the sliding, making it possible for the present embodiment to suppress the increase of the friction coefficient. Further, various configurations may be employed for the configuration of the connection terminal according to the embodiment of the present disclosure, such as a press-fit terminal for press-fitting into a through hole formed through a printed circuit board, other than the fittable female connector terminal or male connector terminal described above.

### EXAMPLES

Now, the present disclosure will be described below with reference to examples. Note that the present invention is not limited to these examples. In the description hereof below, preparation and assessment of the samples were performed in the atmosphere at room temperature unless otherwise noted.

[1] Structure and Characteristics of the Surface Layer

First, the structure and the characteristics of the surface layer containing In and Sn were examined Influence from the content of In was also examined

[Test Method]

(Preparation of the Samples)

Samples A1 to A4 and a sample A0 were prepared by performing the processes below. Specifically, a raw material layer having a specific thickness was laminated onto the surface of a clean Cu substrate as described in Table 1. Specifically, at the start of the process, a 1.0 μm-thick Sn layer was formed directly on the surface of the Cu substrate using an electroplating method. Next, for the samples A1 to A4, an In layer having a specific thickness described in Table 1 was formed on the surface of the Sn layer formed in the above-described manner. The In layer for the sample A1, the thinnest of all the samples A, was formed by an immersion method; and the thickness of the In layer formed was 0.01 μm. For the samples A2 to A4 for which a relatively thick In layer was to be formed, respectively, the In layers were formed by using an electroplating method, and the thickness of the In layer was 0.05 μm, 0.1 μm, 0.2 μm, respectively. For the sample A0, no In layer was formed and the test condition was such that an Sn layer only was formed on the surface of the Cu substrate. Heating (reflow treatment) at 250-300° C. was carried out after the Sn layer and the In layer were laminated together for the samples A1 to A4; while for the sample A0, it was carried out after the Sn layer was formed.

Table 1 illustrates the atomic ratio of In to Sn (In/Sn atomic ratio) as well as the thickness of the formed Sn layers and In layers. The values for the atomic ratio were obtained by converting the thickness of the Sn layer and the In layer into the density of each of Sn and In into the number of Sn and In atoms and by calculating the ratio of In to Sn using the obtained number of Sn and In atoms.

(Assessment on the State of the Surface Layer)

Each of the samples A1 to A4 was observed by scanning electron microscope (SEM) for the state of the surface. Further, the distribution of the structural element on the surface of each sample was determined using energy dispersive x-ray analysis (EDX). The composition of each of the phases observed by SEM was examined based on the element distribution images obtained by EDX; and also, the area ratio of the In-rich portion was estimated.

In addition, x-ray diffractometry (XRD) was carried out by a 2θ method for measurement for the samples A2 to A4 and the composition of the phase generated in the surface layer was assessed. The measurement condition included the following conditions: ω=1°; 2θ=10-80°; 0.03° step.

Further, for the sample A2, measurement by x-ray photoelectron spectroscopy (XPS) was carried out to assess the amount of Sn and In existing on the uppermost surface of the surface layer. Further, Ar⁺ sputtering was carried out during the XPS measurement to assess the depth profile of In. In the measurement and analysis on the depth profile, the oxidation number for In was analyzed based on the obtained photoelectron spectra; the depth of the region in which an oxide of In was distributed, among the In layer, was also analyzed. The XPS measurement was carried out with Al—Kα rays as the light source under the measurement conditions of the angle of incidence of 90° and the photoelectron extraction angle of 45°. The Ar sputtering was carried out down to the depth of 500 nm under the following conditions: acceleration voltage at 2 kV, mean sputter rate at 23 nm/min (SiO₂-equivalent), and it was carried out for each 5 nm of depth.

(Measurement of the Friction Coefficient)

The friction coefficient was measured using the flat plate samples A1 to A4 and A0. In this measurement, an emboss with the radius of 1 mm (R=1 mm) composed of a material including a 1 μm-thick Sn metal film was used for simulation of a pair of terminal contacts including a flat plate contact and an emboss contact. During the measurement, the embossed contact was brought into contact with the surface of each plate-like sample; and the sample was allowed to slide at the rate of 10 mm/min over 5 mm while applying contact load of 3 N. During the sliding, the kinetic friction force applied between the contacts was measured using a load cell. After the measurement, the coefficient of (kinetic) friction was computed by dividing the kinetic friction force by the applied load. Variation of the friction coefficient occurred during the sliding was recorded.

(Assessment on the Contact Resistance)

The contact resistance was measured using the flat plate samples A1 to A4 and A0. For this measurement, a pair of terminal contacts including a flat plate contact and an embossed contact was simulated using an emboss having the radius of 1 mm (R=1 mm) in which a 1 μm-thick Ni intermediate layer and a 0.4 μm-thick Au surface layer. During the measurement, the embossed contact was brought into contact with the surface of each flat plate sample and the contact load was applied, and the contact resistance reached when the contact load was 5 N was measured during these operations. The measurement was carried out by the four-terminal method. The open circuit voltage was set at 20 mV and the energizing current was set at 10 mA.

[Test Result]

(State of the Surface Layer)

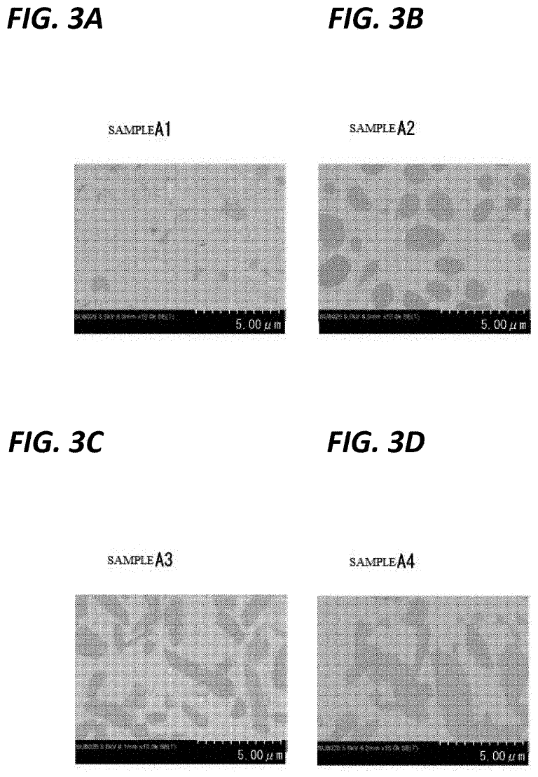

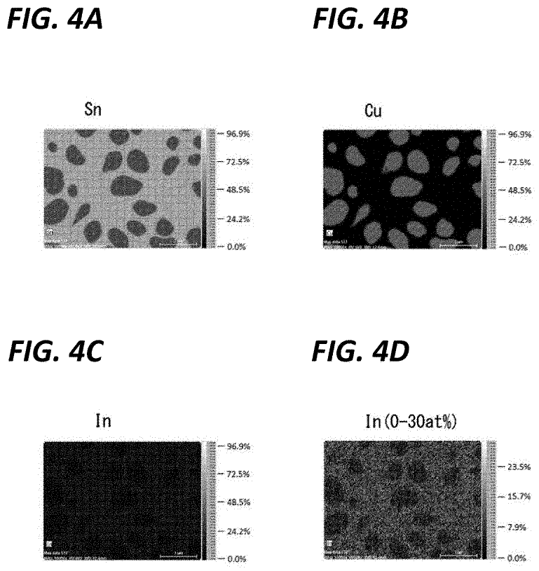

FIGS. 3A to 3D respectively illustrate the SEM images obtained for the samples A1 to A4. These images are reflected electron images obtained at the acceleration voltage of 5.0 kV. FIGS. 4A to 4D illustrate the element distribution of the sample A2 obtained by EDX corresponding to the SEM observation illustrated in FIG. 3B. FIGS. 4A to 4C illustrate the element concentration of Sn, Cu, In, respectively, by the scale of from 0 to 100 atomic % (at %). FIG. 4D illustrates the element concentration of In illustrated in FIG. 4C in the scale of 0-30 atomic %.

Table 1 illustrates the thickness of each raw material layer, the atomic ratio of In to Sn (In/Sn atomic ratio), the type of the generated phase detected by XRD, and the area ratio of the In-rich portion obtained from the element distribution image obtained by EDX for the samples A1 to A4 and A0. Note that phases including Sn or In or both Sn and In were not detected by the XRD measurement except for those illustrated in Table 1.

Further, Table 2 illustrates the concentration of In and Sn (unit: at %) detected for the sample A2 by the XPS measurement on the uppermost surface. Table 2 illustrates the depths of the region in which In was distributed from the uppermost surface obtained by the XPS measurement for depth profile analysis and the depths of the region in which In was distributed in the form of oxides, among the above-described depths.

TABLE 1

| | Raw material layer | | In/Sn | | In-rich |
|---|---|---|---|---|---|
| | thickness [μm] | | atomic | | portion |
| Sample | Sn | In | ratio | | area ratio |
| No. | layer | layer | [%] | Generated phase | [%] |
| A1 | 1.0 | 0.01 | 1.0 | — | 89 |
| A2 | | 0.05 | 5.1 | InSn₄, Cu₆Sn₅, Sn | 72 |
| A3 | | 0.1 | 10 | InSn₄, Cu₆Sn₅, Sn | 59 |
| A4 | | 0.2 | 21 | InSn₄, Cu₆Sn₅, Sn | 57 |
| A0 | 1.0 | None | — | Sn | — |

TABLE 2

| | | |
|---|---|---|
| Element concentration | Depth of | Depth of |
| on the uppermost surface | distribution | distribution |

| In | Sn | of In | of In oxide |
|---|---|---|---|
| 16.8 at % | 9.2 at % | 390 nm | 5 nm |

Referring to the SEM images illustrated in FIGS. 3A to 3D, in each of FIGS. 3A to 3D, regions observed as dark regions are distributed and formed in the islands-like manner in the region observed as relatively bright region. For the sample A2 for which the SEM image is illustrated in FIG. 3B, FIGS. 4A to 4D illustrate the element distribution image obtained by EDX measurement; and in FIGS. 4A to 4D, the island-like structure observed in the SEM image is observed in each element distribution image, and thus it is verified that the island-like structure reflects the spacial distribution of the component composition.

Now the structure of the surface layer will be examined for the sample A2. Focusing on the islands-like region in the element distribution images illustrated in FIGS. 4A to 4D, it is known that each of Sn and Cu is distributed in the islands-like region at a highly homogeneous concentration, as illustrated in FIGS. 4A and 4B. The concentration is higher for Cu. On the contrary, referring to the distribution of In illustrated in FIGS. 4C and 4D, substantially no In is distributed in the islands-like region. From these element distributions, it is understood that a Cu—Sn alloy was formed in the islands-like region. To quantitatively estimate the concentration of Sn and Cu in the islands-like region from the element concentration illustrated in FIGS. 4A and 4B, the ratio of concentration is Sn:Cu=5:6 by atomic ratio. In other words, it is found that the islands-like region has the composition of Cu₆Sn₅. It was verified by the analysis on the generated phase measured by XRD also, of which the result is illustrated in Table 1, that Cu₆Sn₅ was generated as an intermetallic compound.

Next, to focus on the region equivalent to “sea” surrounding the islands-like region, as illustrated in FIG. 4A, it is known that Sn was present at a concentration higher in this “sea” region than in the islands-like region. In addition, referring to the distribution of In illustrated in FIGS. 4C and 4D, also In exists in the region surrounding the islands-like region. On the contrary, referring to FIG. 4B for the distribution of Cu, substantially no Cu exists in the region surrounding the islands-like region. From these facts, it is known that an In—Sn alloy was formed in the region surrounding the islands-like region. To quantitatively estimate the concentration of Sn and In based on the distribution illustrated in FIGS. 4A and 4C, the concentration ration is Sn:In=4:1 in an atomic ratio. That is, it is known that the islands-like region has the composition of InSn₄. It was verified by the analysis on the generated phase measured by XRD also, of which the result is illustrated in Table 1, that InSn₄ was generated as an intermetallic compound.

As described above, it is known, from the results of the SEM observation and EDX measurement, that the regions composed of Cu₆Sn₅ are distributed over in the region composed of InSn₄ in an islands-like manner and that both of such regions are exposed onto the uppermost surface. The islands-like regions can be regarded as corresponding to the Sn-rich portion while the region surrounding the islands-like regions can be regarded as corresponding to the In-rich portion. The area ratio of the In-rich portion illustrated in Table 1 is a ratio calculated for the area of the region surrounding the islands-like regions using the binary data of the convolutionalized EDX image of each element.

Further, referring to the result of analysis for the generated phase measured by XRD, which is illustrated in Table 1, Sn, i.e., Sn element, was observed in addition to InSn₄ and Cu₆Sn₅. No phase other than the above three phases was detected. SEM and EDX are observation for only the region close to the uppermost surface of the sample, while XRD is depthwise observation for the entire region of the sample; and accordingly, referring to FIG. 1A, it is found that an upper layer, in which the Sn-rich portions are distributed in the In-rich portion in an islands-like manner, was formed above a lower layer composed of Sn element in the surface layer. The lower layer is considered as a part of the Sn layer laminated as the raw material layer not consumed for the formation of the surface layer.

Now, the results of the XPS analysis on the surface of the sample A2 illustrated in Table 2 will be examined In and Sn were detected in the observation on the uppermost surface. To compare the concentration between Sn and In, the concentration was higher for In. The In/Sn atomic ratio over the entire surface layer was 5.1%; and from this result, it is found that In was charged in an amount smaller than the amount of Sn and that In was distributed at locations close to the surface of the metal material at a high concentration instead of being distributed depthwise in a homogeneous manner in the form of an alloy with Sn. This supports a model that was found from the results of the EDX and XRD observations in which the upper layer containing both In and Sn was formed above the lower layer composed of Sn. As a result of the depthwise analysis, the depth of the region of the surface layer containing In was 390 nm.

Further, as a result of the depthwise analysis, oxidized In of In contained in the surface layer was distributed only in the regions 5-nm deep from the uppermost surface. In this regard, it is considered that the oxidation of In was advanced in a state in which In was in the form of an In—Sn alloy, and because the depth of the regions in which the oxidized In was distributed was as shallow as 5 nm, it is found that most of such In, i.e., In existing in the regions with the depth ranging from 5 nm to 390 nm was in a state of non-oxidized metal. As a result, the characteristics such as solid lubricity exhibited by In in a state of metal can be intensely exerted in the surface layer. As can be known from the result of the measurement for the contact resistance described below, the In oxide film as thin as about 5 nm can be easily broken, and the high conductivity exerted by In in the state of metal contributes to the electric connection at the contact portions.

As described above, it was verified that in the metal material for the sample A2, the lower layer composed of Sn was formed on the surface of the substrate, and the upper layer was formed on the surface of the lower layer, having the structure in which a Cu—Sn alloy (Cu₆Sn₅) was distributed in the In—Sn alloy (InSn₄) in an islands-like manner. Further, it was found that in the region in which the In—Sn alloy was formed, In maintained its state of non-oxidized metal except for the very shallow regions close to the uppermost surface. Although not described herein, EDX measurement was carried out for the samples A1, A3, and A4; and it was verified that similar to the results for the sample A2, Sn-rich portions composed of a Cu—Sn alloy were formed in the islands-like regions observed by the SEM observation and In-rich portions composed of an In—Sn alloy were formed in the region surrounding the islands-like regions. Further, as illustrated in Table 1, the phase composed of InSn₄, the phase composed of Cu6Sn₅, and the phase composed of Sn were detected for all of the samples A1 to A4 also by the XRD measurement. It is considered from this result that in any of the samples A1 to A4, a structure similar to the structure described and clarified above for the sample A2 was formed on the surface of the surface layer.

Now the state of the uppermost surface of the surface layer will be compared between the samples A1 to A4. Referring to FIGS. 3A to 3D for the SEM images, it is known that as the In/Sn atomic ratio becomes higher from FIG. 3A to FIG. 3D, the anisotropy of the shape becomes higher in the islands-like region corresponding to the Sn-rich portion and the area becomes larger. In other words, the area of the In-rich portion decreases as the In/Sn atomic ratio becomes higher. This is further clearly shown by such a behavior that the area ratio of the In-rich portion becomes lower as the In/Sn atomic ratio increases from the sample Al to the sample A4 as illustrated in Table 1. Although the details of the mechanism in which the exposed area of the In-rich portion increases as the content of In increases are not known for the present, the above result shows that the area of exposure of the In-rich portion can be controlled in accordance with the In/Sn atomic ratio.

(Characteristic of the Surface Layer)

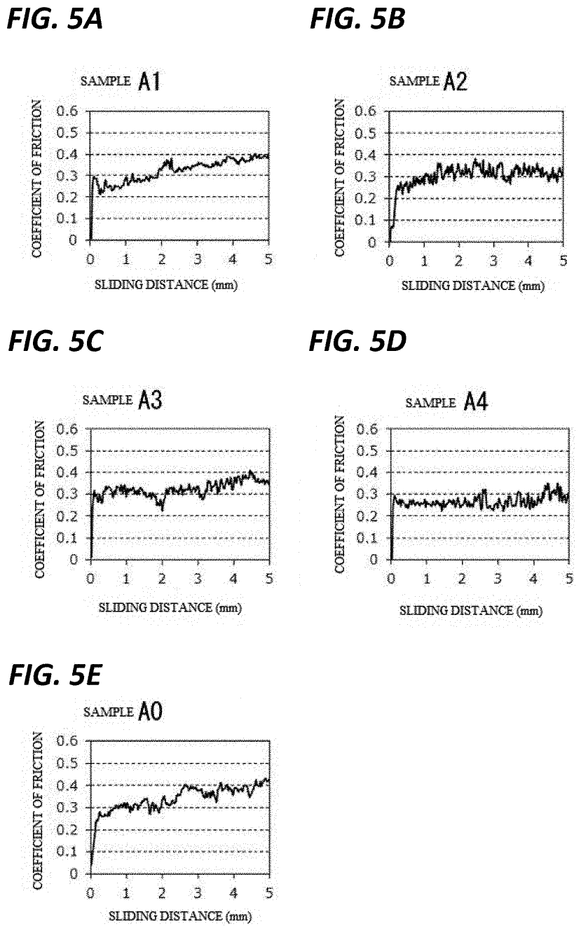

FIGS. 5A to 5E illustrate the result of measurement for the friction coefficient. FIGS. 5A to 5D illustrate the results for the samples A1, A2, A3, and A4, respectively; FIG. 5E illustrates the result for the sample A0. Each graph illustrates the sliding distance on the horizontal axis and the friction coefficient for each sliding distance on the vertical axis.

The increase of the friction coefficient that occurs as the sliding advances (as the sliding distance increases) was gentler for the examples illustrated in FIGS. 5A to 5D in which the surface layer containing In was formed compared with the configuration illustrated in FIG. 5E in which the Sn layer only was formed on the substrate surface. In addition, the values themselves were smaller for the former configuration. The friction coefficient rose as the sliding advanced in the example in which the Sn layer only was formed due to the adhesion among Sn between the Sn layer on the surface of the plate-like sample and the Sn layer on the surface of the emboss; while in the example in which In was included in the surface layer of the plate-like sample and distributed on the uppermost surface, the increase in the friction coefficient that may otherwise occur due to adhesion of Sn was suppressed due to the solid lubricity exerted by In. In the sample Al, although the content of In in the surface layer was as low as 1% in an atomic ratio to Sn, the effect of suppressing the increase of the friction coefficient was obtained even with the small amount of In.

Particularly in the examples illustrated in FIGS. 5B to 5D in which the amount of In contained in the surface layer was large, both the effect of suppressing the increase of the friction coefficient and the effect of decrease of the values of the friction coefficient themselves occurring as the advance of the sliding were high. It is considered preferable that the content of In in the surface layer be controlled to 5% or more in an atomic ration in relation to Sn.

Further, Table 3 below illustrates the measurement result for the contact resistance for each sample as well as the thickness of each raw material layer and the In/Sn atomic ratio.

TABLE 3

| | Raw material layer thickness | | | Contact |
|---|---|---|---|---|
| Sample | [μm] | | In/Sn atomic | resistance |
| No. | Sn layer | In layer | ratio [%] | [mΩ] |
| A1 | 1.0 | 0.01 | 1.0 | 0.70 |
| A2 | | 0.05 | 5.1 | 0.52 |
| A3 | | 0.1 | 10 | 0.73 |
| A4 | | 0.2 | 21 | 0.80 |
| A0 | 1.0 | None | — | 1.03 |

Referring to Table 3, the low contact resistance of approximately the same level was obtained for all of the samples A1 to A4 in which the surface layer contained In, which was lower compared with the ample A0 in which the Sn layer only was formed. Even if In was distributed on the uppermost surface of the surface layer, as verified by the result of the XPS measurement, the oxidation of In occurred only in the shallow region close to the surface layer and the oxide film could be easily broken; and thus the In oxide did not increase the contact resistance in the surface layer. This can be explained that the In—Sn alloy exposed onto the uppermost surface of the surface layer as the In-rich portion was softer than Sn and thus the contact resistance was even lower than that in the example in which the Sn layer only was formed. The effect of decreasing the contact resistance was sufficient even in the sample A1 with the lowest In/Sn atomic ratio of 1.0% among the samples.

To compare the contact resistance among the samples A1 to A4 each containing In by the content different from others, the effect of decreasing the contact resistance increased from the sample A1 to the sample A2, in which the content of In was increased from 0.01% to 0.05% in the In/Sn atomic ratio. However, the contact resistance in the samples A3 and A4 including In by a higher content than the sample A2 was larger compared with the samples A1 and A2. It is considered that the contact resistance increased for larger In content occurred in accordance with the decreased area ratio for the In-rich portion illustrated in Table 1. In other words, this is explained that the area ratio for the In-rich portion decreased for larger In content, and as a result, the effect of decreasing the contact resistance exerted by the In-rich portion decreased. From this result, the content of In in the surface layer is preferably controlled at 20% or less, more preferably at 15% or less, in the In/Sn atomic ratio.

From these results described above, it was verified that the increase in the friction coefficient was able to be suppressed and also the contact resistance was able to be controlled to be low by employing a configuration in which the substrate contains In and Sn on its surface and the surface layer was formed containing In distributed on its uppermost surface. These effects are explained as exerted due to the solid lubricity and the easiness of breaking oxide films exerted by In.

[2] Relationship Between Alloying in and the Characteristics of the Surface Layer

Next, examination was performed as to what influence in the surface layer characteristics is imparted by the alloying advanced by the heating performed after the In layer and the Sn layer was laminated together.

[Test Method]

(Preparation of the Samples)

An In layer was formed on the surface of an Sn layer as a sample B1, a sample not to be subjected to heating. Specifically, similar to the sample A2, a 1.0 μm-thick Sn layer was formed on the surface of a Cu substrate by an electroplating method. Then the sample was heated at 250 to 300° C. Further, a 0.05 μm-thick In layer was formed on the surface of the heated Sn layer by an electroplating method. After the In layer was formed, the sample was not heated.

As a sample B2, a separate sample including an In layer on the surface of the Sn layer was formed, which was heated. Specifically, a 1.0 μm-thick Sn layer was formed during the above-described process of preparing the sample B1 and then a 0.05 pm-thick In layer was formed in the process of preparing the above-described sample B1 without performing heating. After the In layer was formed, the Sn layer and the In layer were laminated together, and the sample was heated at 250 to 300° C. The sample B2 was produced in a similar manner as the sample A2. In addition, a sample B0 was prepared in which a 1.0 μm-thick Sn layer was formed on the Cu substrate and the sample was heated at 250-300° C., similar to the sample A0.

(Measurement of the Friction Coefficient)

In a similar manner as the above Test [1], a terminal contact pair was simulated and used together with an embossed contact having an Sn layer for flat plate-like samples B1, B2, and B0; and the friction coefficient was measured. The conditions were the same as those for the above Test [1] except that the contact load was 5 N.

[Test Result]

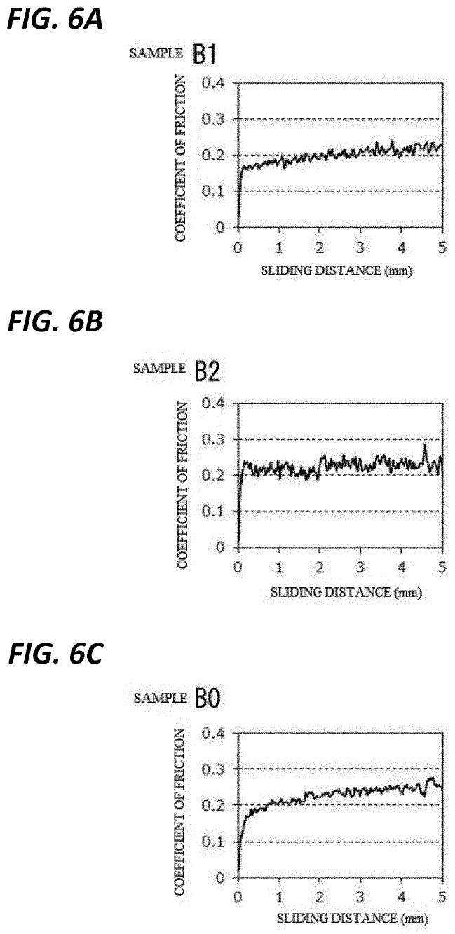

FIGS. 6A to 6C illustrate the result of the measurement of the friction coefficient for the samples B1, B2, and B0, respectively. Each graph illustrates the sliding distance on the horizontal axis and the friction coefficient for each sliding distance on the vertical axis.

Referring to FIGS. 6A and 6B for the result of measurement of the friction coefficient for the samples B1 and B2, for the samples B1 and B2, the increase of the friction coefficient that occurs as the sliding advances was gentler for each example illustrated in FIGS. 6A and 6B compared with the result for the sample B0 illustrated in FIG. 6C, in which the Sn layer only was formed. In addition, the values themselves were smaller for the examples illustrated in FIGS. 6A and 6B. Particularly in the sample B2 illustrated in FIG. 6B, for which heating was carried out after the In layer was formed, the increase of the friction coefficient that might otherwise occurred as the sliding advanced was less than the example of the sample B1 illustrated in FIG. 6A, for which heating was not carried out after the In layer was formed.

By carrying out heating after forming the In layer, alloying between In and Sn can be promoted. In the sample B1 which was not heated after the In layer was formed, the degree of advance of the alloying was not so high; and it is likely that In not having been alloyed with Sn remained as residue. On the contrary, in the sample B2 for which heating was carried out after the In layer was formed, the total quantity of In contained in the surface layer was alloyed into an In—Sn alloy and exposed onto the uppermost surface of the surface layer, similar to the state observed using EDX and XRD for the sample A2 in the above Test [1].

The above result in which the increase in the friction coefficient was suppressed regardless of whether heating was performed or not shows that addition of In in the surface layer enables exertion of the effect of suppressing the increase of the friction coefficient thanks to the presence of In regardless of whether the alloying with Sn was completely advanced and whether the degree of advance of the alloying was low. To paraphrase this, it is considered that if the surface layer contains In, the increase of the friction coefficient can be suppressed regardless of whether an In—Sn alloy is formed or not. Provided, however, if the alloying is completely advanced by carrying out heating, the effect can be further increased.

[3] Influence from the Component of the Substrate

Finally, the influence from the metal material composing the surface of the substrate on the characteristics of the surface layer was examined.

[Test Method]

(Preparation of the Samples)

A surface layer was prepared as each of samples C1 to C3 using a substrate including an Ni intermediate layer formed on its surface. Specifically, a 1.0 μm-thick Ni layer was formed on the surface of a clean Cu substrate using an electroplating method. An Sn layer and an In layer were formed in this order on the surface of the substrate on which the Ni intermediate layer was formed, using an electroplating method. The thickness of the Sn layer was the same for each sample at 1.0 μm. The thickness of the In layer was set at 0.05 μm, 0.1 μm, 0.2 μm for the sample C1, C2, C3, respectively. The samples in which each metal layer was formed were respectively heated at 250-300° C. The method of preparing the samples C1 to C3 was similar to the preparation method for the samples A2 to A4 except that the Ni intermediate layer was formed. Further, a sample C0 was formed, in which no In layer was formed and an Sn layer only was formed on the surface of the Ni intermediate layer, which was heated at 250-300° C.

(Assessment on the State of the Surface Layer)

The sample C2 was subjected to XRD measurement in a similar manner as Test [1] described above and the composition of the phase generated in the surface layer was assessed.

(Assessment on the Characteristics of the Surface Layer)

In a similar manner as the above Test [1], a terminal contact pair was simulated and used together with an embossed contact having an Sn layer for the flat plate-like samples C1 to C3; and the friction coefficient was measured. Further, in a similar manner as the above Test [1], a terminal contact pair was simulated and used together with an embossed contact having an Au layer for the flat plate-like samples C1 to C3 and C0; and the contact resistance was measured.

[Test Result]

As a result of the XRD measurement for the sample C2, the following three phases were detected as phase generated in the surface layer. Specifically, three phases including Sn, InNi, and InSn₄ phases were detected. It is considered that among the three phases mentioned above, the Sn phase composed the lower layer of the surface layer, and the upper layer of the surface layer was composed of a mixture of the coexisting InNi and InSn₄ phases. It was verified that by heating the material including a lamination of the Sn layer and the In layer even if the surface of the substrate contains Ni as described above, a surface layer can be formed containing both Sn and In respectively existing in the form of an alloy.

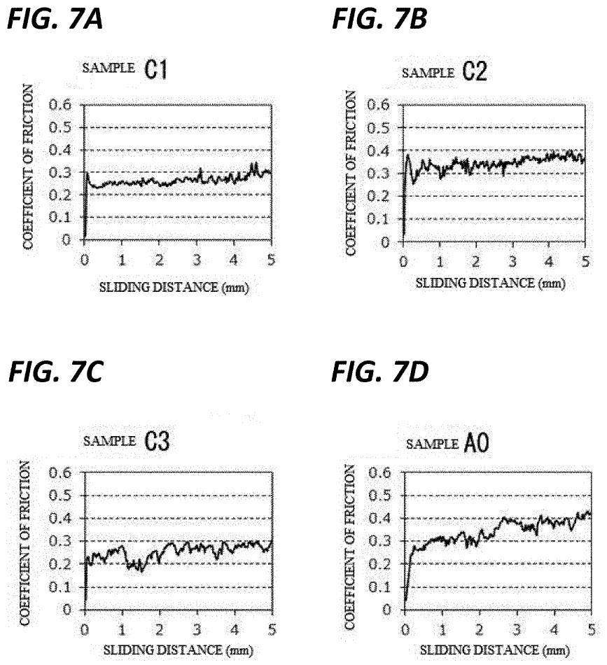

FIGS. 7A to 7C illustrate the result of the measurement of the friction coefficient for the samples C1 to C3, respectively. Each graph illustrates the sliding distance on the horizontal axis and the friction coefficient for each sliding distance on the vertical axis. FIG. 7D illustrates the measurement result for the sample A0 illustrated in FIG. 5E again, in which the Sn layer was formed on the surface of the Cu substrate for easier comparison. In the samples C1 to C3 with the measurement results illustrated in FIGS. 7A to 7C, respectively, the increase of the friction coefficient that occurs during the sliding was gentler compared with the example illustrated in FIG. 7D in which the Sn layer only was formed on the surface; it is thus known that the increase in the friction coefficient was suppressed in the samples C1 to C3. In addition, the values themselves were smaller for the samples C1 to C3 compared with the example illustrated in FIG. 7D.

Table 4 below illustrates the measurement values for the contact resistance for the samples C1 to C3 and the sample C0.

TABLE 4

| | | | | Contact |
|---|---|---|---|---|
| Sample | Raw material layer thickness [μm] | | | resistance |
| No. | Ni layer | Sn layer | In layer | [mΩ] |
| C1 | 1.0 | 1.0 | 0.05 | 0.88 |
| C2 | | | 0.1 | 0.79 |
| C3 | | | 0.2 | 0.87 |
| C0 | 1.0 | 1.0 | None | 0.68 |

Referring to Table 4, the contact resistance was higher for the samples C1 to C3 in which the surface layer containing In and Sn was formed compared with the sample C0, in which the Sn layer only was formed on the Ni primary layer. However, even in the samples C1 to C3, the contact resistance values were controlled to values of 0.9 mΩ or less, i.e., values sufficiently low for the contact resistance for connection terminals.

As described above, even in the examples in which a surface layer containing In and Sn was formed on the surface of the Ni primary layer, the increase of the friction coefficient was suppressed better than the configuration in which the Sn layer only was formed in the surface layer, and the contact resistance of substantially the same level as that in the configuration in which the Sn layer only was formed in the surface layer. To paraphrase this, for the samples A1 to A4 including Cu on the surface of the substrate and also for the samples C1 to C3 including Ni on the surface of the substrate, if the metal material includes the surface layer containing In and Sn, the suppression of the increase of the friction coefficient can be achieved, and also the sufficiently low contact resistance can be obtained. Accordingly, it is considered that even in configurations in which Sn and In form an alloy with the metal element composing the substrate and if the alloy composes a part of the surface layer, effects such as suppressed increase of the friction coefficient and reduction of the contact resistance can be achieved as effects exerted by the entire surface layer due to the contribution from In contained in the surface layer.

An embodiment of the present disclosure is as described in detail above, however, the present invention is not limited to the above-described embodiment by any means, and can be implemented by various modifications and alterations within the scope not deviating from the gist of the present invention. The present application claims priority to Japanese Patent Application No. 2019-058128 filed on Mar. 26, 2019, which is incorporated herein by reference in its entirety.

### LIST OF REFERENCE NUMERALS

1 Metal material

10 Surface layer

10a Sn-rich portion

10b In-rich portion

11 Upper layer

12 Lower layer

15 Substrate

20 Female connector terminal

21 Elastic contactor

21a Emboss portion

22 Inner counter contact surface

23 Clamping portion

30 Male connector terminal

1. A metal material comprising:
a substrate; and
a surface layer covering a surface of the substrate,
wherein the surface layer includes Sn and In, and
wherein at least In exists on an uppermost surface.

2. The metal material according to claim 1, wherein in the surface layer, at least a part of In is in a state of an In—Sn alloy.

3. The metal material according to claim 2, wherein the In—Sn alloy comprises InSn₄.

4. The metal material according to claim 1, wherein
the surface layer comprises:
an Sn-rich portion including Sn and in which a concentration of In is lower than a concentration of Sn; and
an In-rich portion including In at a concentration higher than the concentration of In in the Sn-rich portion, and
wherein both the Sn-rich portion and the In-rich portion are exposed onto an uppermost surface of the surface layer.

5. The metal material according to claim 4, wherein the In-rich portion comprises an In—Sn alloy.

6. The metal material according to claim 4, wherein the Sn-rich portion comprises an alloy of a metal element composing the substrate and Sn.

7. The metal material according to claim 4, wherein a ratio of an area occupied by the In-rich portion in the uppermost surface of the surface layer is higher than 50%.

8. The metal material according to claim 4, wherein the ratio of the area occupied by the In-rich portion in the uppermost surface of the surface layer is 90% or less.

9. The metal material according to claim 1, wherein a concentration of In on the uppermost surface of the surface layer is 10 atomic % or more.

10. The metal material according to claim 1, wherein a content of In in the surface layer is 1% or more in an atomic ratio in relation to Sn.

11. The metal material according to claim 1, wherein the content of In in the surface layer is 25% or less in an atomic ratio in relation to Sn.

12. The metal material according to claim 1, wherein in the surface layer, In is distributed at least in regions ranging from the uppermost surface to a depth of 0.01 μm.

13. The metal material according to claim 1, wherein the surface of the substrate comprises at least either one of Cu and Ni.

14. A connection terminal comprising:
the metal material according to claim 1,
wherein the surface layer is formed on the surface of the substrate at least in a contact portion for electric contact with a counterpart conductive member.

15. The connection terminal according to claim 14, wherein a metal including Sn is exposed onto a surface of the counterpart conductive member.
